(19) United States
(12) Patent Application Publication
(10) Pub. No.: US 2010/0021027 A1
(43) Pub. Date: Jan. 28, 2010

(54) IMAGE DATA MANAGEMENT SYSTEMS

(76) Inventors: Thomas Hartkens, Erlangen (DE); Michael Burns, London (GB); Shahid Jamil, London (GB); Derek Hill, London (GB)

Correspondence Address: FRASER CLEMENS MARTIN & MILLER LLC, 28366 KENSINGTON LANE, PERRYSBURG, OH, 43551, US

(21) Appl. No.: 12/248,953

(22) Filed: Oct. 10, 2008

(30) Foreign Application Priority Data
Jul. 25, 2008 (GB) 0813672.3

(51) Int. Cl. G06K 9/00; G06F 17/30

(52) U.S. Cl. 382/128; 707/104.1; 707/E17.044

(57) ABSTRACT

A data management system for managing medical imaging data comprises a memory storing a workflow data set defining a plurality of tasks to be performed on the imaging data and a processing system arranged to: receive input data including the imaging data; control the performance of each of the tasks on the input data; and make amendments to the workflow data set recording the results of each of the tasks and an audit trail of the amendments made to the imaging data during the tasks.

### FIELD OF THE INVENTION

The present invention relates to data management systems and in particular to systems for managing data, such as medical image data, which may be collected in clinical trials, such as those trials assessing the safety and efficacy of new medicine, or trials studying disease progression, or in personalized medicine. While clinical trials are generally trials on patients or other human subjects, the system is also applicable (though the regulatory environment is different) for studies involving animal imaging, and the term ‘clinical trials’ should be understood to include trials involving animals.

### BACKGROUND OF THE INVENTION

In clinical trials that involve imaging endpoints, there is a need to control the import, data cleaning, analysis and export of the images with associated metadata in a way that meets the relevant regulations for the conduct of clinical trials (e.g. patient privacy legislation, ICH-GCP and 21 cfr pt 11). The regulations require that the data is suitably de-identified, that a full audit trail is maintained of all tasks performed on the data using either automatic computerized methods or interactive methods, and that the tasks to be performed by users are performed by people that are suitably qualified and trained to perform those tasks. Furthermore, the data must be tracked through all these stages so that the progress of the data through the system is clearly visible for example by real-time generation of reports itemizing the number of images that have been received, cleaned, analyzed etc.

The data involved come from numerous different locations (sometimes 100s of hospitals in dozens of countries contribute to one trial), and labelling errors are common (the subject identifier may be wrong, or one particular type of image may be mislabelled so the analysis required on that image is unclear), so data cleaning to correct these errors is essential prior to analysis.

Imaging can be used to assess many properties of new medicines, including their efficacy, safety, and the optimal dose. For safety assessment there are particular regulatory requirements, as information about a possible safety problem (“adverse event”) must be communicated to the people looking after the patient on the trial, and the trial safety monitoring commitee very rapidly. Rapid scheduling of safety-related tasks, rapid communication of results to designated people and tracking of these processes is necessary.

Current systems used by image analysis companies and central labs make use of multiple computerized or paper-based systems that are integrated at a course level, but do not provide a fully integrated, “image aware” system that works from the import of the images at the sites (or from the upload from a removable media sent to a central lab) through to the delivery of the endpoints results with full audit trial to the sponsor or regulator. As a result, there is a need for a lot of additional procedures and internal auditing to ensure that these procedures are followed, which adds to the cost. Furthermore, reconciliation of data related issues (for example subject or imaging protocol identifiers) in different systems can be a complex process if it needs to be performed manually.

Some embodiments of the invention can provide a technical solution to this problem that provides one or more of the following: image import, data cleaning, tracking, scheduling of tasks to suitably trained and qualified people, and export of data while maintaining a full audit trail.

There is also a closely related problem in healthcare—sometimes referred to as personalized medicine—in which data is collected from patients undergoing carefully defined (“protocoled”) diagnostic tests at regular intervals to track disease progression and/or response to treatment. Imaging examinations are often a key part of these tests and some embodiments of this invention can also be applied to managing data collected from one or more subjects undergoing these tests, ensuring comparable data is collected, subject identification is consistent, that the data is viewed or analysed in a standardized way with a full audit trail. A secondary use of data in this healthcare application is clinical audit for improving evidence based medicine, which requires the ability to aggregate comparable data from large numbers of subjects, and embodiments of this invention can be applied to that task also.

### SUMMARY OF THE INVENTION

The present invention provides a data management system for managing imaging data in the system comprising a memory storing a workflow data set defining a plurality of tasks to be performed on the imaging data and processing means arranged to receive input data including the imaging data, to control the performance of each of the tasks on the input data, and to make amendments to the workflow data set recording the results of each of the tasks and an audit trail of the amendments made to the imaging data during the tasks.

The medical data may be for use in clinical trials such as those trials assessing the safety and efficacy of new medicine, or trials studying disease progression, or in personalized medicine.

The imaging data may include image data and metadata. The images may be of any type of subject, which may be a human or animal subject or phantom used to check or calibrate the system. The image data may be from any type of image, including radiological images such as MRI, CT, PET, X-ray, ultrasound, DEXA etc. The metadata may define at least one parameter of the collection of the image data, for example a parameter relating to the subject or the circumstances of the data acquisition.

The processing system may be further arranged to control upload of the input data. The system may further be arranged to carry out a validity check on the data before uploading it. The system may further be arranged to upload the data only if it passes the validity check, or if a user specifically confirms that the data is valid. The validity check may include a check against previous data uploaded from the same subject.

The system may be arranged to export the data set, including at least one of the original data, modified data and a full audit trail (with digital signatures) in a form that can be easily browsed on a computer storage device without the need for a database or search facility. The exported data may be organized as a series of HTML web pages that can be browsed using a personal computer. The exported data can be generated using one or more search criteria to provide a selected subset of the total data set.

Preferred embodiments of the present invention will now be described by way of example only with reference to the accompanying drawings.

### BRIEF DESCRIPTION OF THE DRAWINGS

FIG. 1 is a diagrammatic representation of a data management system according to an embodiment of the invention

FIG. 2 is a functional representation of the data management system of FIG. 1;

FIG. 3 is a flow diagram showing operation of an upload tool forming part of the system of FIG. 1;

FIG. 4 is a functional diagram showing operation of a workflow system of the system of FIG. 1;

FIG. 5 is a functional diagram showing performance of an automatic task within the system of FIG. 1;

FIG. 6 is a functional diagram showing further operation of the workflow system of FIG. 1;

FIG. 7 is a functional diagram showing allocation of a manual task within the system of FIG. 1;

FIG. 8 is a diagram showing recordal of data relating to a manual task within the system of FIG. 1;

FIG. 9 is a flow diagram showing an overview of the creation of an electronic paper-trail within the system of FIG. 1, and

FIG. 10 is a flow diagram showing a digital signature process used in an embodiment of the invention.

### DESCRIPTION OF THE PREFERRED EMBODIMENTS

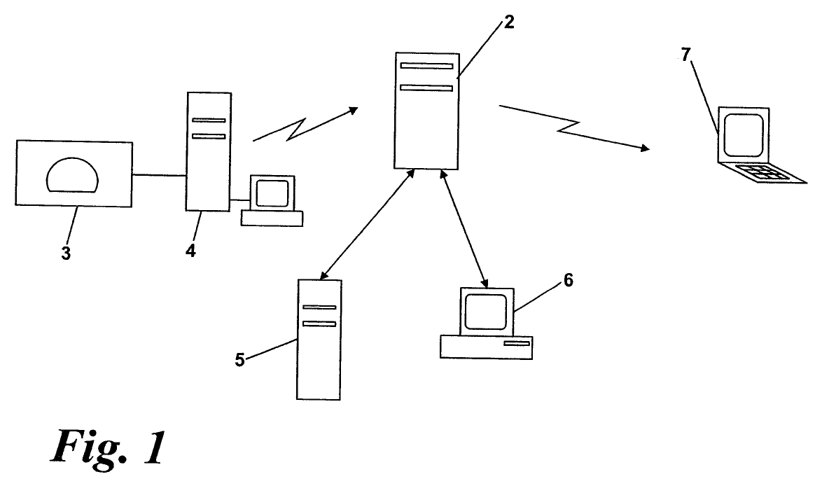

Referring to FIG. 1, an image data management system is arranged to manage data on a central server 2 at a central site. Data can be uploaded from a number of scanners 3 at respective scanner sites, via computers 4 at the scanner sites, or written to removable media and subsequently loaded onto the system using a computer at the same or another site or the central lab running the trials. Tasks can be scheduled by the server 2 to computers 5, if they can be performed automatically, and to workstations 6 if they are to be performed manually. The results of the trial can be reported to a client system 7. Results can also be reported back to scanner sites, For example the results may relate to whether the data supplied is suitable for the required analysis (correctly collected, labelled and transferred), and to the required action to be taken at the scanner site (examples of which include: re-collecting the data, re-transmitting data, resolving labelling ambiguities, or improving local site practice for subsequent imaging examinations).

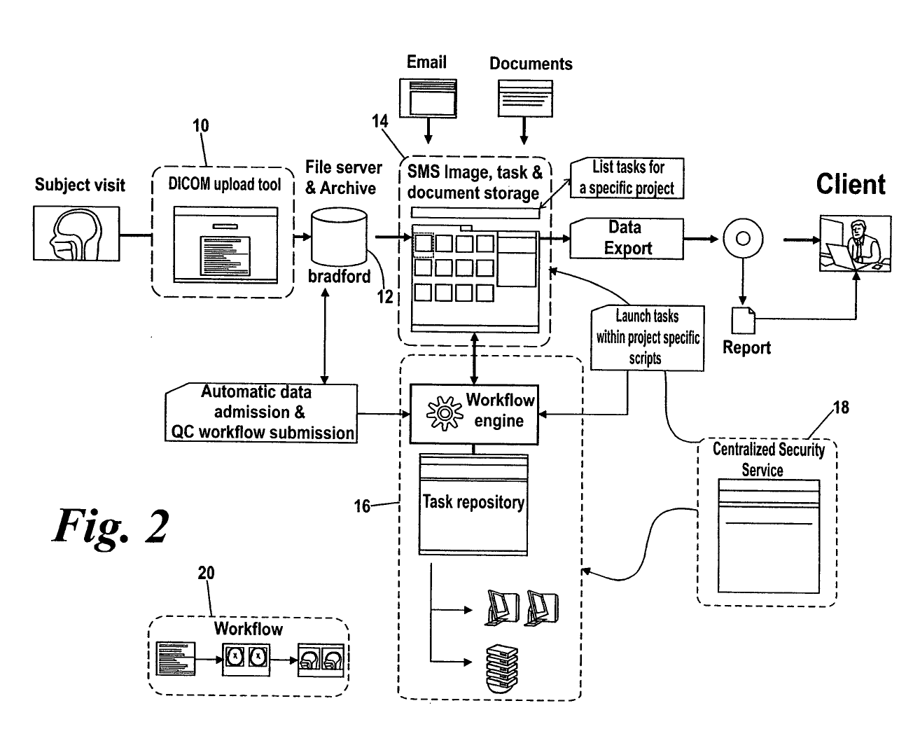

Referring to FIG. 2 the imaging data management system comprises an upload tool 10 located on, or accessed through, the computer 4 at the scanner site, or another site, and arranged to control the uploading of imaging data in this case including image data and associated metadata, from the scanning site or from a data storage device such as a disk. A data store 12 in the form of a file server and archive is arranged to receive and store files uploaded by the upload tool 10. A study management system (SMS) 14 runs on the central server 2 and is arranged to retrieve data from the data store 12 and store other files, for example defining tasks to be performed by the system while the system is in operation, and to export files such as report files containing the results of the various processes carried out by the system. A workflow controller 16 also runs on the central server 2 and is arranged to control the performance of automatic operations on the data, and the allocation of manual operations to appropriate operators, and to maintain a record of the operations performed. A centralized security service 18 also running on the central server contains records of approved operators. For each operator the record contains identity data and a definition of the tasks they are authorized to perform.

### Workflow System

For any particular trial a formal representation of the analysis and modification workflow to be performed on the image data and metadata in the trial is contained in a workflow description (WD) specific to that trial. The analysis and modification may include one or more of: quality control (such as fraud detection), data cleaning and image analysis. This workflow description may be contained in a single WD file or may be contained in a number of files. These files are xml files in this embodiment, but other file formats can be used. The WD files can contain dynamic scripting content to provide substantially more functionality than standard workflow systems, because it enables the scripts to provide flow control, and also allows definition of computations within the workflow system without the need to schedule a task using web services, enabling faster deployment and greater functionality in terms of configuration of the data that are then sent to subsequent workflow components for analysis. This workflow representation forms the starting point for the collection of data from the trial. Imaging data is added to this file, and modified data such as imaging data which has been modified by automatic processes, or manual processes, is added to the file, together with an audit trail recording all modifications to the data. The workflow file can reference (via a source code repository) the precise version of any data analysis, or modification workflows to be run on the system, such that the WD file captures the version of all software components used in the system for a particular trial. This file is then also used to provide reports on the trial when it is completed. The workflow system is designed so that it
enables the automatic execution of image analysis tasks
allows to the system to keep a record of the execution of all tasks (audit trail)
serves as a record for the provenance of image analysis results (in one file, which can be sent to third parties easily)
enables a unified description of highly complex image analysis tasks, involving both interactive and automatic components.
provides a record of the software versions used to complete all tasks
enables scheduling of interactive tasks to people who are trained, qualified and available to perform those tasks
describes and controls automatic and interactive tasks, the records from which can be digitally signed and, therefore, fulfils regularity requirements
allows the database independent storage of image analysis audit trails
enables progress reports to be generated from searches of the workflow system
provides for communication to external parties e.g. enabling them to raise data queries or be advised of adverse events.

In this embodiment the data analysis and modification tasks are described in a single xml workflow description (WD) file 20. This file provides a description of the imaging data expected at each point in the trial, the key metadata to be used in the analysis, and tasks to be performed, with full specification of the configuration of the software components, and the order in which the tasks will be performed. This file can optionally include a trial configuration file containing a summary of the clinical trial protocol indicating exactly which sorts of data are expected from each subject visit during the trial, and how many days or weeks into the trial each visit is expected to take place.

### Trial Configuration File

In this embodiment a trial configuration file is set up for each trial and provides a representation of the data expected from the trials, the relevant metadata required for the interpretation and analysis, the tasks to be performed, and the metadata validation required. It defines the quality control (QC) checks needed on the data, and the contacts to which any communication should be sent automatically (e.g. if a safety read has evidence of an adverse event, a message needs to be sent to the investigator at the site where that subject was recruited). Optionally example data (images etc.) of the sort expected can be included in the configuration file so that all admitted data can be checked automatically and/or interactively against the reference data. Parts of the trial configuration can be updated automatically from a separate computer system eg: Clinical Trial Management System if available, to ensure reconciliation of all sources of trial data.

### Data Admission

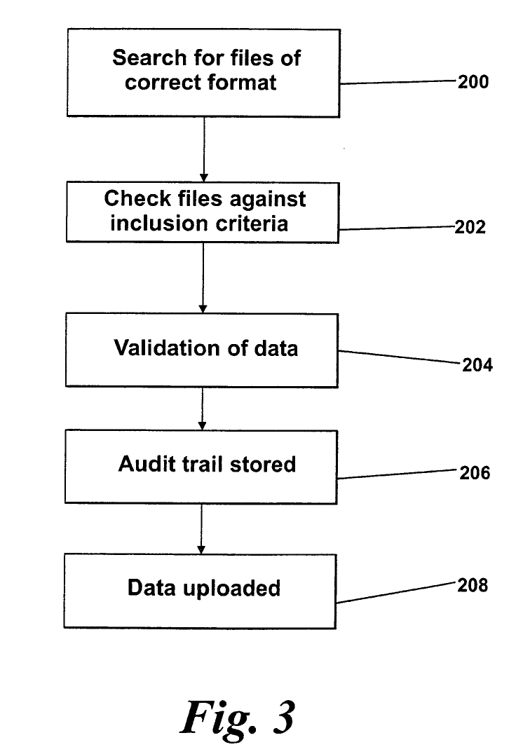

Referring to FIG. 3, the upload tool 10 performs data transfer from the scanner site where the subject is scanned, or from a storage medium on which it is stored after the scan has been performed. The upload tool 10 includes a java applet running in a web browser and is used to admit data directly from the scanning site, or from any other location to which the images have been sent (e.g. by CD). A “wizard” style is used, guiding the user through the data admission process. In this embodiment, the admission is done for one subject and one time point at a time.

Data admission is controlled by the trial configuration file and the upload tool is arranged to highlight data that meets the criteria defined in the trial configuration file, and optionally to only admit the data meeting these criteria (otherwise the user can select non-highlighted data to send, and optionally provide a comment justifying this decision). The upload tool also performs de-identification of personal data (e.g. as required for HIPAA compliance in the USA—http://www.hhs.gov/ocr/hipaa/), and initial cleaning and QC of the data (e.g. to ensure labelling is as expected and that the correct image acquisition protocol has been run). For baseline scans, the labelling and image acquisition protocol checking is done against the parameters set in the trial configuration file. For subsequent timepoints, the checking is optionally also done against previous images acquired from the same subject. The trial configuration file determines the times at which data is expected and what subject data is expected at each upload time point. It also specifies what metadata is required with the image data (both metadata from the image header that needs importing and checking, and additional metadata that is not in the header), and the checks to be performed on the data. At each upload, the upload tool is arranged at step 200 to search for files of the correct general format, for example DICOM images, on the disk or other source from which data is uploaded. Those files are then checked at step 202 to determine which of them meet the inclusion criterion defined in the trial configuration file. Those that do are flagged to indicate that they are to be uploaded. Prior to upload, a validation step is performed on the data to be uploaded at step 204. This includes checking the metadata that is in fields defined by the trial configuration file against the requirements also specified in that file. For example the metadata can be checked to ensure that it is valid data, that it includes the correct format of subject identifier, and that the data has been correctly acquired in terms of number of slices and scanner parameters, that it was acquired on or around the correct date etc. Image analysis tasks can optionally be built into the QC where sufficient computing power is available, for example to compare the acquired image with a reference image to determine whether the correct part of the subject has been scanned, to compare the image with a previous image of the same subject to check for consistent acquisition and subject labelling, or to detect motion S artefact. If the subject identifier is not in the expected format, then it can be changed by the upload tool. For example if it is a name, then the validation step can include changing the name to a number of the correct number of digits for the trial. An additional reconciliation step can be used to query the previously uploaded data from the same subject stored on the server 2 to validate that the new data is consistent. At step 206 an audit trail of any change to subject-identifiable information is stored at the site (normally by printing it out and the user signing it as a correct record) rather than transferred to the central server. Finally at step 208 the validated data is uploaded. The uploaded data (images and metadata) is stored in a data repository that may involve a relational database, xml files, operating system filing system, or combination of these. This data may be on a single computer, or a distributed network of computers that can be queried centrally. The data may also be sent simultaneously to more than one computer e.g.: to the trial sponsor and to one or more suppliers each of which may be performing a specific image analysis tasks for the sponsor.

The admission process is customizable on a per-trial and per-site basis using the trial configuration file, which enables the data validation to be very specific to the expected data from that site and that trial. The validation rules are implemented as regular expressions which are transferred to the memory of the machine running the web browser upload tool, and which gives great flexibility in the specification of the validation process (e.g. checking that metadata is of the expected format, or values in the metadata are in the expected range). Where a baseline scan of a subject has already been uploaded, the validation rules can include checking against the baseline data. Because the regular expressions are transferred to the local machine, the metadata does not need to be transferred to the server 2, and therefore remains within the site 4 that collected the data.

Where image QC involving checking image values rather than just metadata values is performed at upload, it can either take place on the local machine (if sufficient computational capability is available), or on the server 2.

Two audit trails are generated by the system. The first relates to any changes to personally identifiable data that is removed in the de-identification processes. This first audit trail therefore relates to changes made at the clinical site, and never leaves the clinical site that collected the data. A second audit trail records any modifications or additions to the non-patient-identifiable metadata. If these changes are carried out at the clinical site, then the audit trail is transferred to the server along with the images. This audit trail is continued with further changes made to the data at the server 2 or other sites to which tasks are delegated by the server 2.

An important challenge in any system that transfers data from a hospital site to a remote server, is getting through the firewall and other security system in place in the hospital. This embodiment deals with that problem by hunting for a suitable transport protocol that is not blocked by the network, and selecting the most secure of the available transport protocols (e.g. HTTP over SSL would be the first choice, with secure ftp the second choice, and ordinary HTTP a third choice). The acceptable transport protocols, and their order of preference, are defined in the trial configuration file. To ensure that no files are lost or modified during the transfer from the site to the server 2, the hash sum of each file is calculated by the computer at the clinical site, and checked by the server 2 on arrival. The total number of files transferred is also checked.

### Scheduling of Tasks

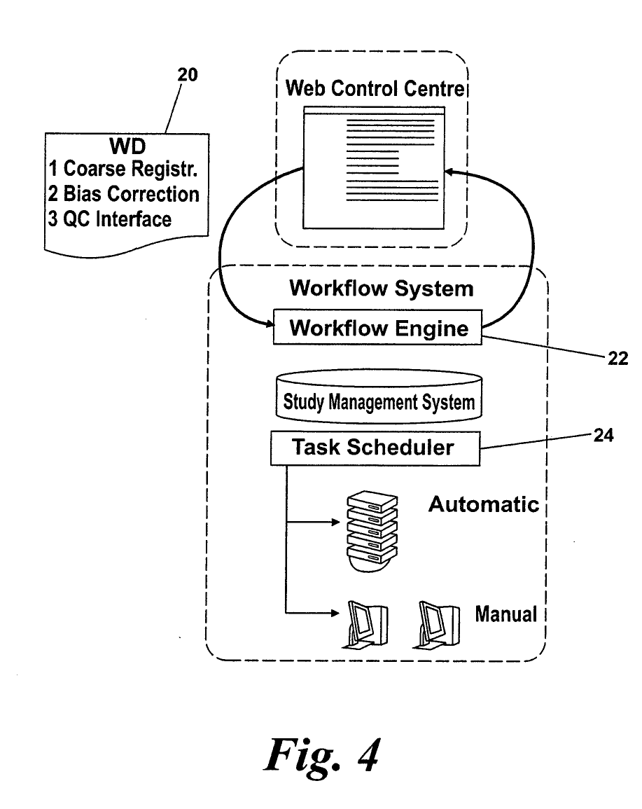

Referring to FIGS. 2 and 4, the workflow controller 16 includes a workflow engine 22 that, during any trial, reads the workflow description file, and, with the aid of a task scheduler 24, controls the execution of all the relevant tasks on suitable computers or workstations as required for that trial. Some tasks are automatic, such as image analysis and correction steps and some are manual being preformed by a user, generally working on a workstation. The workflow engine 22 is arranged to identify from the WD file each task that needs to be performed, and to monitor the performance of each task to ensure that where appropriate they are performed in the correct order or at the correct time as defined in the WD file 20. When each task is performed, the results of the task, for example modified imaging data, are added to the WD file together with associated metadata indicating for example the time at which the task was performed, the computer on which it was performed, the user who performed the task if the task is a manual task, and any relevant data regarding the performance of the task, such as any errors arising in its performance.

Any specific manual task in the workflow is only scheduled to users who are approved to perform that task, e.g. because their qualifications and experience have been assessed as suitable and they have completed the required training, and are available. The approved users are each defined by a respective record in the centralized security service part 18 of the system.

All results from all tasks are written back into the file, and are digitally signed to ensure that the person or system that performed the task is recorded and that any subsequent tampering can be detected. The WD file 20 thus contains an audit trail of the analysis, and a signed record for the trial.

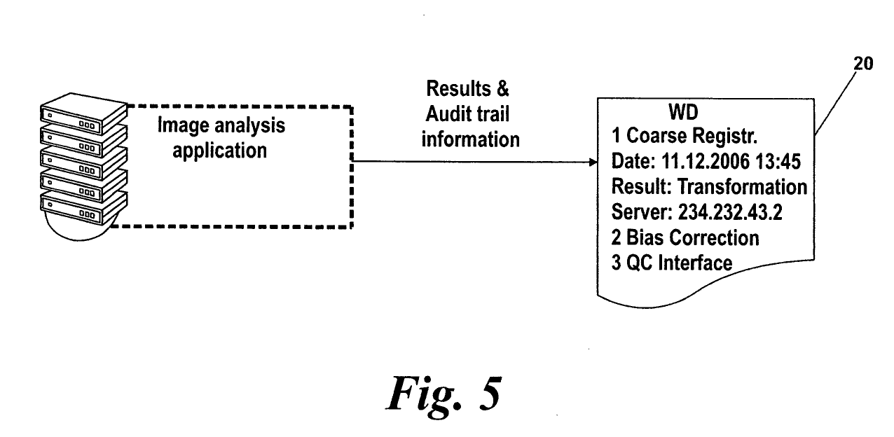

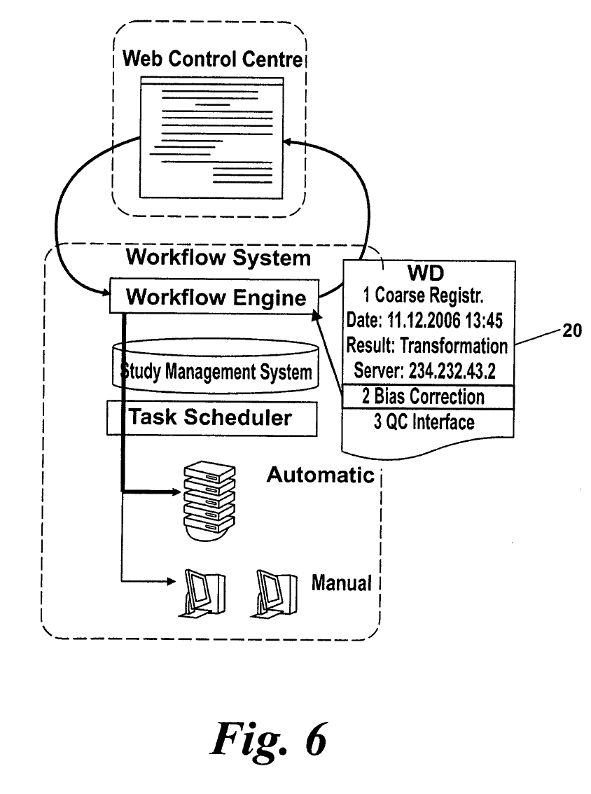

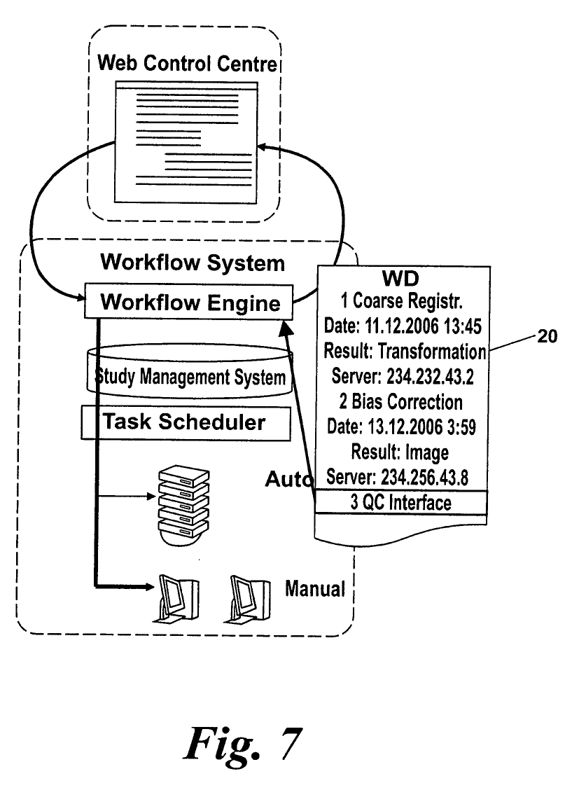

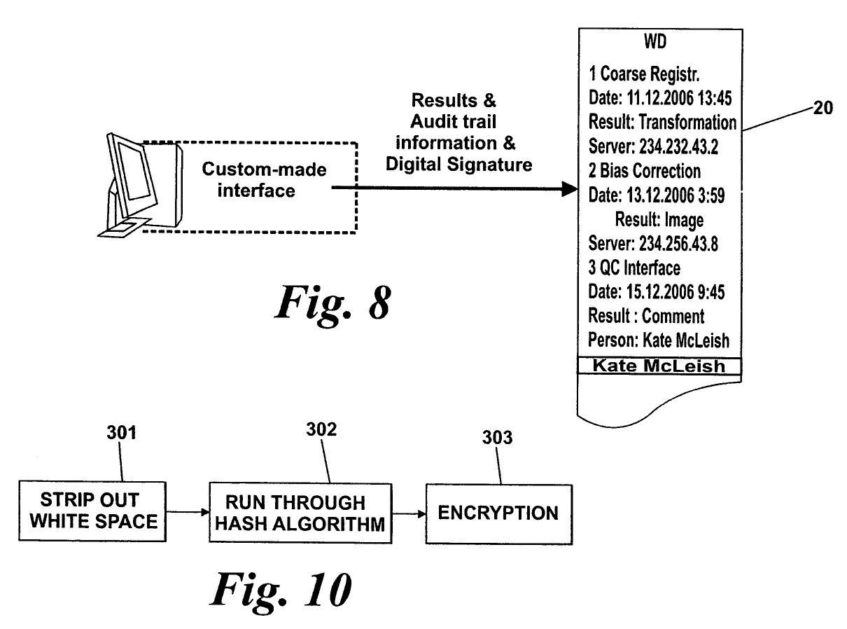

In this example, the WD file 20 defines three steps to be performed: coarse image registration, bias correction and a quality control step. Referring to FIG. 5, the workflow engine 22 requests the task scheduler 24 to select and instruct a computer 40 to perform the coarse image registration using an image analysis application, and then on receiving the registered image, writes the modified image and metadata indicating the date and time of the operation and the identity of the computer on which it was performed, to the WD file. Then, referring to FIG. 6, the workflow engine 22 requests the task scheduler 24 to select and instruct a computer to perform the second step of bias correction. Again this is performed and the results of the correction and associated metadata written to the WD file. Then referring to FIG. 7, the workflow engine 22 requests the task scheduler 24 to schedule the manual QC task to an appropriate user. The task scheduler 24 identifies and selects an appropriate user to perform the QC task. An optional integrated viewer is included in the system that is launched with a configuration defined by the WD file, with task specific instructions displayed for the selected approved user to perform. Referring to FIG. 8, when the steps are performed, an audit trail including a record of the analysis steps, signed by the user with a digital signature, is written into the same WD file 20.

The scheduler 24 can make available to the user 6 or computer 5 performing the task, data from previous time-points or reference data as required, to assist the user or computer system in performing the tasks.

For tasks with a critical response time (e.g. image QC and safety reads), the user-interface launched at the workstation 6 in response to the centrally controlled scheduling includes a button to send an email/fax to the contact specified in the trial configuration file.

### Data Cleaning and QC

Data cleaning and Quality Control can be scheduled by the workflow engine as part of the workflow control defined in the WD file. These steps involve a mixture of automated checking of metadata against reference values (as defined in the trial configuration file), automatic steps that incorporate image analysis (e.g. to identify subject positioning errors) and tasks scheduled to trained analysts.

An additional interface forming part of the workflow control system allows any problems with the analysis to be resolved, e.g. further cleaning of mis-labelled data that is identified part way through the analysis of a trial, or labelling of data that is considered of insufficient quality for analysis, or selecting tasks that need to be repeated. A full audit trail is maintained of any changes made using this interface.

### Scheduling of Analysis Tasks

Safety measurements (normally a trained user viewing—“reading” images and scoring for unexpected image features that have arisen during the trial) and efficacy measurements (measurements of change in body structure or function during the course of the trial) are performed according to defined workflows, which can involve numerous steps. The workflow language supports nesting and limited flow control to enable complex combinations of tasks to be performed. For automatic tasks, the processing is scheduled to a suitable computer with the relevant software running locally or remotely. For the interactive tasks, a user has to launch a monitor on their system to indicate their availability, and tasks for which they are approved (qualified and trained) can then be scheduled to their system. For most tasks, all results are digitally signed and stored in the WD file as part of the audit trail. For time-critical tasks (e.g. safety measurements) a message can instantly be sent to the appropriate contact as defined in the trial configuration file directly from the user interface, as well as the digitally signed record being stored in the WD file.

### Search, Reporting and Export

Referring to FIG. 9, once all of the tasks have been performed and the results written to the WD file 20, the WD file is then complete, and can be checked and signed digitally by a further user so as to form a compete record of the trial. The WD file then contains all the imaging data in its originally received and modified forms, all associated meta-data, and a complete audit trail including details of all amendments made to the WD file. For a typical trial which lasts over a long period of time, the WD file forms a record of the progress of the trial. As new imaging data is added at each stage of the trial the appropriate tasks are performed on it and the associated amendments to the file digitally signed.

Search capability allows all of the records within the WD file to be browsed, and for sub-sets of records to be viewed. These searches can be used to generate real-time reports on trial progress, or to generate the final results for submission to trial sponsors or regulators. Any field in the data repository (e.g. in the relational database tables or xml tags), containing information such as subject details, admitted metadata and results can be searched in an integrated way.

Reports are generated by running a query that produces an output file (e.g. csv) that can be generated as required. These queries can be defined at the start of the trial and run on a regular basis to produce regular (e.g. daily) reports to project manager or customer. Queries can also be run live from a web interface or directly.

Search terms can be used to select either all, or a subset, of the images and associated audit trail that can be exported from the system onto a storage device (either fixed or removable) to provide a complete record of the trial, including the original (source) data, the full record of any changes to the data (e.g. correcting for mis-labelling as part of cleaning), any comments by analysts performing the tasks, and the final results. This exported audit trail is formatted using the trial configuration file so that this exported data is structured in accordance with what is expected for the trial, and any missing data can be easily seen. This audit trail can be browsed with any web browser, and without the need for the workflow engine or any databases.

The embodiments of the invention described, therefore, provide a technical solution to the problem described through: an upload tool that can de-identify and perform initial cleaning of DICOM imaging data by taking a DICOM image and a configuration file as input and generating the clean data and an audit trail as output (with the audit trail of de-identification being restricted by the technology to remain at the acquiring site); a system that can follow image analysis instructions written in a workflow file, schedule tasks to users that are approved for those tasks, and then write the results back into the workflow file and permit digital signing of this file.

Software packages that handle XML files are inconsistent in the way they handle white spaces (e.g. formatting data such as line feeds, carriage returns, tabs and spaces) in these files. This does not matter for normal use of XML files as these white spaces are typically ignored by applications. For digital signing, however, it is critical that no white spaces are added or removed following signing. This is because the digital signing process for a file includes running the file through an algorithm, such as a hash algorithm, that generates an output number dependent on the entire contents of the file, and then encrypts the number using the sender's private key to produce the signature. On receipt the signature is decrypted using the sender's public key and the number compared with a corresponding number generated from the received file. If the compared numbers are different, then this indicates that the file has been altered after sending. Hence, adding or removing white spaces would be interpreted by the digital signature system as tampering with the content of the signed message.

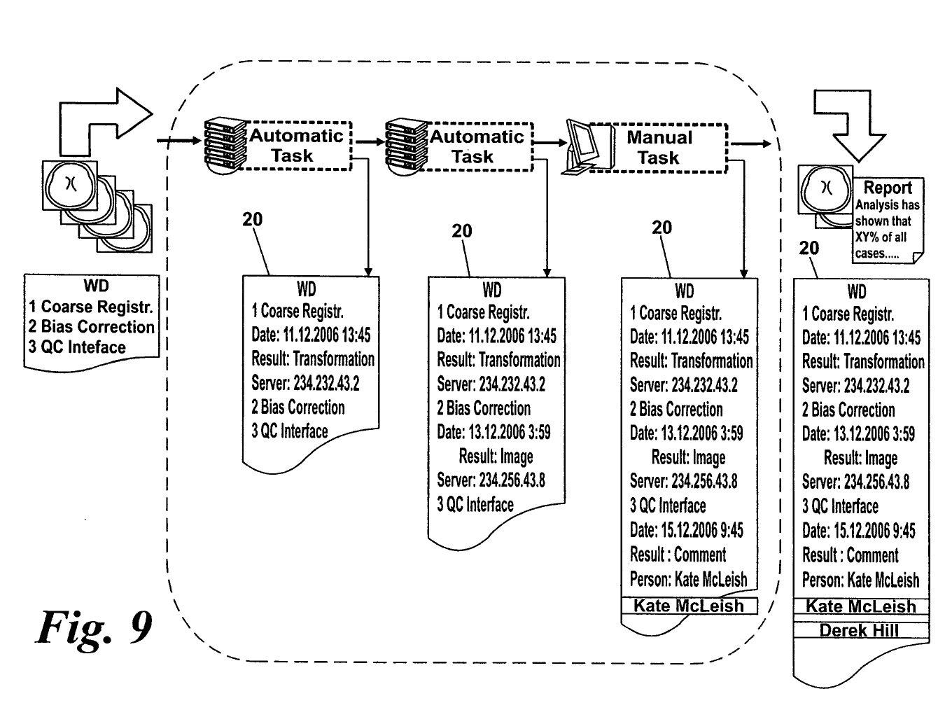

Referring to FIG. 10, this embodiment therefore includes a digital signature system in which the digital signing of the xml file includes a step 301 of stripping out all white spaces from the xml file prior to signing. The signing process includes the steps of running the file through a hash algorithm 302 to generate an output number, and encrypting the number using the sender's private key 303. The step of stripping out white space is also carried out prior to verification of a correct signature, circumventing the problem that a given application programme may have added white space between signing and checking without altering the content of the XML in any relevant way.

Finally the system incorporates a sub-system that generates a complete record of the original data, interim results and full audit trail in a data-base independent way. This database independent storage approach maximises the chance that an archive of this data will still be readable decades later, as it is written in html, with the images in DICOM, both of which are likely to be standards that last for decades, whereas more propriety or less widely used formats are likely to be unreadable in more than 10 or 20 years. Furthermore, the MD5 checksums are contained in this file and could be used to check for tampering with the data following export.

This embodiment of the invention provides a fully integrated solution to a task that is often done using multiple computer systems that are coarsely integrated, or using a mixture of computer based and paper systems. The integrated approach provides additional functionality compared to other systems, e.g. the “one button” complete export of the full audit trail including source images and interim results, and also removes risk of breach of regulatory requirements by enforcing tasks to happen in a highly controlled way. For example, the system will prevent a task being performed by someone who has not been approved (qualified and trained etc.) to perform that task, whereas competing approaches do not enforce this, but rely on employees following procedures. Similarly the integrated system of this embodiment ensures that reconciliation is performed prospectively rather than at the end of a trial, so that subject or image mis-labelling, or data that is not acquired in the way or at the time expected, is all identified as the data is uploaded rather than through a subsequent reconciliation process. The system can automatically generate query messages (e.g.: emails or faxes) to inform the relevant parties, such as the acquisition site, of any of these data deficiencies to enable rapid resolution.

The invention provides an integrated system to manage the data for imaging in clinical trials. It is a fully integrated system that works from the import of the images at the sites (or from the upload from a removable media sent to the central lab) through to the delivery of the endpoints results with full audit trial to the sponsor or regulator, with real-time tracking of all events. It includes scheduling of all interactive images viewing or analysis tasks to users who have been approved to perform those tasks, and those users signing that they have performed that task using digital signatures

It will be appreciated that though the embodiment described includes a central server that performs the workflow control, it is equally possible for the system to be a distributed system in which various different control functions or tasks are performed on different computers, which may be remote from each other.

1. A data management system for managing medical imaging data, the system comprising a memory storing a workflow data set defining a plurality of tasks to be performed on the imaging data and a processing system arranged to receive input data including the imaging data, to control the performance of each of the tasks on the input data, and to make amendments to the workflow data set recording the results of each of the tasks and an audit trail of the amendments made to the imaging data during the tasks.

2. A system according to claim 1 wherein at least one of the tasks can be performed on a computer and the processing system is arranged to control performance of said at least one of the tasks by the computer.

3. A system according to claim 1 wherein at least one of the tasks can be performed by a user and the processing system is arranged to schedule said at least one of the tasks for performance by the user.

4. A system according to claim 3 wherein the processing system contains a record of a plurality of users each authorized to perform at least one task, and the processing system is arranged to select one of the users to perform at least one of the tasks on the basis of the record.

5. A system according to claim 1 wherein the imaging data includes image data defining at least one image and metadata defining at least one parameter of the collection of the image data.

6. A system according to claim 5 wherein one of the tasks comprises an image processing task arranged to modify the image data.

7. A system according to claim 5 wherein one of the tasks comprises a quality control task in which the imaging data is checked against at least one quality criterion.

8. A system according to claim 7 where the quality control task has an output defining at least one of a problem with the data and a corrective courses of action to correct the problem, and the system is arranged to identify a recipient for the output and to communicate the output to the recipient.

9. A system according to claim 7 wherein the quality control task comprises identifying reference data which includes reference image data, and comparing at least a part of the image data with the reference image data to check that the image data and the reference image data relate to a corresponding anatomical region.

10. A system according to claim 1 wherein the data set comprises a single file.

11. A system according to claim 1 wherein the data set is contained within at least one xml file.

12. A system according to claim 1 arranged to store the data set in a searchable format.

13. A system according to claim 1 wherein the processing system is further arranged to control upload of the input data.

14. A system according to claim 13 wherein the processing system is arranged to determine from the workflow data set an expected format of data for uploading and to search for data of the expected format.

15. A system according to claim 13 wherein the processing system is arranged to perform at least one validity check on data before uploading it

16. A system according to claim 13 wherein the processing system is arranged to remove personal data from the data before uploading it.

17. A system according to claim 13 wherein the processing system comprises a main processor and an uploading processor wherein the main processor is arranged to control the performance of the tasks on the data after it has been uploaded and the uploading processor is arranged to control uploading of the data.

18. A system according to claim 17 wherein the uploading processor is remote from the main processor.

19. A system according to claim 11 further arranged to enable digital signature of the xml file and, prior to the digital signature, to remove white space from the xml file.

20. A computer implemented method of managing medical imaging data, the method comprising generating a workflow data set defining a plurality of tasks to be performed on the imaging data, receiving input data including the imaging data, performing a plurality of tasks on the input data, and making amendments to the workflow data set recording the results of each of the tasks and an audit trail of the amendments made to the imaging data during the tasks.
